(19) United States
(12) Patent Application Publication
(10) Pub. No.: US 2026/0209027 A1
(43) Pub. Date: Jul. 23, 2026

(54) ECTO-CROWN ERGONOMIC CROWN PIECE SYSTEM FOR EQUINE BRIDLES WITH INTEGRATED BROWBAND PASSAGE

(71) Applicant: Kimberly Marie King, APOPKA, FL (US)

(72) Inventor: Kimberly Marie King, APOPKA, FL (US)

(21) Appl. No.: 19/455,788

(22) Filed: Jan. 21, 2026

Related U.S. Application Data
(60) Provisional application No. 63/747,531, filed on Jan. 21, 2025.

(51) Int. Cl. B68B 1/04

(52) U.S. Cl. CPC B68B 1/04

(57) ABSTRACT

An ergonomic crown piece system for equine bridles featuring bilateral bifurcated zones that create strategic browband passage openings. Each bifurcated zone includes an upper leather strap and a lower leather strap separated by a gap. The browband threads through the passage openings and loops around the upper leather straps, ensuring that only the lower leather strap contacts the horse's head. This design eliminates the traditional three-layer bulk at the browband attachment point, reducing pressure in the critical poll region behind the ears and above the temporomandibular joint. The system provides enhanced comfort, improved anatomical fit, and allows easy browband interchangeability while maintaining structural integrity and control function across various bridle configurations.

### CROSS REFERENCE TO RELATED APPLICATIONS

This claims priority to U.S. Provisional Patent Application 63/747,531 filed on Jan. 21, 2025 and is incorporated in its entirety.

### FIELD OF THE INVENTION

The present invention relates to equestrian equipment, and more particularly to an ergonomic crown piece design for horse bridles that provides improved comfort and fit by incorporating a novel browband attachment configuration through a channel that reduces pressure points on the equine poll region and temporomandibular joint area.

### BACKGROUND

Traditional horse bridle crown pieces, whether straight or curved, are constructed with a continuous leather strap that passes over the horse's poll (top of the head behind the ears) and these conventional designs include the browband being threaded loosely and insecurely through loops on both sides of the crown piece, creating a two-layer configuration at the browband attachment point: the crown piece and the browband loop, which is exposed around the crown piece and can move or slip during motion.

This traditional construction creates several anatomical and functional challenges. First, the crown (whether straight or curved) can add unnecessary bulk at a critical juncture immediately under the horse's ears and above the temporomandibular joint (TMJ). This insecured material creates pressure points that can cause discomfort, particularly during extended wear or when the horse moves its head. Additionally, traditional crowns with the browband looped over the crown lack secure placement and with some crowns, resulting in the browband sitting too high and forcing it to sit against the ears, or too low and creating pressure on the TMJ.

Second, the conventional loop configuration prevents secure placement and proper adjustment of the browband position relative to the horse's unique anatomical features.

Third, the currently available straight or curve crowns create uneven pressure distribution across the poll region and behind the ears. When tension is applied through the reins and bit, the forces can be transmitted through the material, concentrating stress at the loop attachment points rather than distributing it evenly across the crown piece. This can lead to rubbing, hair loss, and sensitivity in the poll area, and an unhappy horse.

Existing bridles have attempted to address comfort through S-curve shapes, latent to and continue by anatomically shaped crown pieces that curve around the ears. However, these solutions fail to secure the browband and address the fundamental structural problem created by the traditional browband loop configuration. The loose loops remain, creating unnecessary movement and pressure points where there should be none.

Additionally, traditional designs limit the aesthetic and functional customization options for riders who wish to change browbands without affecting the fit and function of the crown piece. The fixed loops dictate the position and orientation of the browband, preventing optimal individualization based on each horse's unique head shape and the rider's preferences. Additionally, traditional designs lack the smoothness on the underside of the crown at the location of the browband due to the lack of continuous leather that can allow for dirt, sweat, and other debris to build up in a very sensitive area.

Therefore, there exists a need for a crown piece system that eliminates the traditional loose browband loop, provides a secure and anatomically optimized browband attachment method, reduces pressure points in the poll and around the ears and TMJ regions, allows for superior adjustability, and still maintains structural integrity and control function while accommodating the natural anatomy of the equine head when standing and moving while in motion.

### SUMMARY

The present disclosure is directed to a crown piece modification for horse bridles that features a strategic opening between two pieces of leather at the browband location, referred to as a browband channel. This innovative design allows the browband to pass through the opening and be securely looped around the top piece of leather, thereby ensuring that only one piece of the crown leather contacts the horse's head, eliminating the traditional browband slippage/movement and places the continuous calfskin leather at the very sensitive area just under the ear vs the browband loop protruding beyond the crown at the contact center. For all embodiments of FIGS. 1-4, the browband channel prevents the browband from slipping and gives a smoother continuous piece of leather against the very sensitive area where the browband lays on the horse's head, removing some of the friction and potential build up of sweat, dirt and debris that could get trapped in the conventional browband that loops over the top of the crown leather. The shape of the crown around the ears and over the poll is better shaped to conform more correctly than conventional and even “ergonomic” crowns.

In some aspects, the techniques described herein relate to an ergonomic crown piece system for equine bridles including: a crown piece body member extending from a first lateral side to a second lateral side across an equine poll region; a bifurcated zone located at positions corresponding to browband attachment points on both lateral sides; wherein the bifurcated zone includes an upper leather strap and a lower leather strap with a strategic gap therebetween; a browband passage opening formed by the gap between the upper and lower leather straps, the passage opening dimensioned to receive a browband therethrough; wherein the browband is configured to loop around the upper leather strap after passing through the browband passage opening; and wherein the lower leather strap maintains direct contact with the equine head in a region posterior to the ears and superior to the temporomandibular joint, creating anatomical clearance and reducing pressure points.

In some aspects, the techniques described herein relate to an ergonomic crown piece system, wherein the browband passage opening has a vertical dimension of approximately 1.5 to 2.0 inches, though this may vary based on browband width and equine anatomy.

In some aspects, the techniques described herein relate to an ergonomic crown piece system, wherein the bifurcated zone is positioned to place the browband passage opening in a location immediately posterior to the equine ear base and superior to the temporomandibular joint.

In some aspects, the techniques described herein relate to an ergonomic crown piece system, wherein the upper leather strap and lower leather strap maintain substantially parallel orientation within the bifurcated zone.

In some aspects, the techniques described herein relate to an ergonomic crown piece system, wherein the crown piece body member includes a throat latch component.

In some aspects, the techniques described herein relate to an ergonomic crown piece system, wherein the bifurcated zones are symmetrically positioned on both lateral sides of the crown piece.

In some aspects, the techniques described herein relate to the crown piece being properly fitted around the horse's ears to provide comfort and proper fit.

In some aspects, there will be raised leather on the rear of the crown and/or the front located just behind the ears, preventing slippage of the bit/cheek pieces relative to a single or double bridle.

In some aspects, the techniques described herein relate to a crown piece system for equine bridles including: a crown piece body member extending from a first lateral side to a second lateral side across an equine poll region; a first bifurcated zone located at a first lateral position corresponding to a first browband attachment point; and a second bifurcated zone located at a second lateral position corresponding to a second browband attachment point

In some aspects, the techniques described herein relate to a crown piece system, wherein each bifurcated zone includes an upper leather strap; a lower leather strap; and a browband passage opening formed by a gap between the upper leather strap and the lower leather strap.

In some aspects, the techniques described herein relate to a crown piece system, further including a browband, wherein the browband is configured to pass through the browband passage opening and loop around the upper leather strap.

In some aspects, the techniques described herein relate to a crown piece system, wherein the lower leather strap is configured to maintain direct contact with an equine head in a region posterior to equine ears and superior to a temporomandibular joint.

In some aspects, the techniques described herein relate to a crown piece system, wherein the browband passage opening has a vertical dimension of approximately 1.5 to 2.0 inches.

In some aspects, the techniques described herein relate to a crown piece system, wherein the browband passage opening has a vertical dimension ranging from 1.0 to 3.0 inches based on browband width and equine anatomy.

In some aspects, the techniques described herein relate to a crown piece system, wherein each bifurcated zone is positioned to place the browband passage opening immediately posterior to an equine ear base and superior to the temporomandibular joint.

In some aspects, the techniques described herein relate to a crown piece system, wherein the upper leather strap and the lower leather strap maintain substantially parallel orientation within each bifurcated zone.

In some aspects, the techniques described herein relate to a crown piece system, wherein the crown piece body member includes an integrated throat latch component.

In some aspects, the techniques described herein relate to a crown piece system, wherein the first bifurcated zone and the second bifurcated zone are symmetrically positioned on both lateral sides of the crown piece body member.

In some aspects, the techniques described herein relate to a crown piece system, further including reinforcement stitching at transition zones between the crown piece body member and each bifurcated zone.

In some aspects, the techniques described herein relate to a crown piece system, wherein the lower leather strap includes cushioning material on a surface configured to contact the equine head.

In some aspects, the techniques described herein relate to a crown piece system, wherein the crown piece body member includes a throat latch component having a curved slope towards the neck from the crown, wherein the curved slope is configured to position the throat latch forward on the cheek to prevent interference with the throat and reduce movement during use.

In some aspects, the techniques described herein relate to a crown piece system, further including a raised leather edge on a rear surface of the crown piece body member configured to prevent slippage of bit straps or noseband straps across the back of the crown.

In some aspects, the techniques described herein relate to a crown piece system, further including a raised leather area on a front surface of the crown piece body member located near the back of the ears, wherein the raised leather area is configured to provide a more secure fit.

In some aspects, the techniques described herein relate to a crown piece system, further including permanent keepers positioned on both lateral sides of the crown piece body member, wherein the permanent keepers are configured to prevent slippage of bit straps or noseband straps.

In some aspects, the techniques described herein relate to a crown piece system, wherein the crown piece body member includes ear cutouts configured to provide clearance for the equine ears, wherein the crown piece body member has a contoured shape around the ears and over the poll region that conforms to equine anatomy.

In some aspects, the techniques described herein relate to a crown piece system, wherein the browband passage opening forms a browband channel that secures the browband against slippage and provides a continuous leather surface against the equine head, thereby reducing friction and preventing accumulation of sweat, dirt, and debris.

In some aspects, the techniques described herein relate to a crown piece system, further including bit straps that attach independently and buckle on a top portion of the crown piece body member, wherein the independent attachment allows switching between single and double bridle configurations.

In some aspects, the techniques described herein relate to a method of assembling a bridle with an ergonomic crown piece system, including: providing a crown piece body member having first and second bifurcated zones, each bifurcated zone including an upper leather strap, a lower leather strap, and a browband passage opening therebetween; threading a browband through the browband passage opening of the first bifurcated zone; looping the browband around the upper leather strap of the first bifurcated zone; threading the browband through the browband passage opening of the second bifurcated zone; looping the browband around the upper leather strap of the second bifurcated zone; and positioning the crown piece body member on an equine head such that the lower leather straps contact the equine head posterior to ears and superior to a temporomandibular joint.

### BRIEF DESCRIPTION OF THE SEVERAL VIEWS OF THE DRAWINGS

FIG. 1 shows a view of one embodiment of the crown piece, which can be used as a single or double bridle configuration. The embodiment of FIG. 1 includes raised leather on both the front and back of the crown located near the back of the ears, with the raised leather edge on the back designed to prevent any slippage of the bit/noseband straps from crossing over the back of the crown, in addition to two sets of permanent keepers on both sides that also prevent slippage. The raised area by the ears can help secure a more snug fit for feisty horses.

FIG. 2 shows a view of another embodiment of the crown piece, which is the same as FIG. 1 except that the raised leather behind the ears is omitted, as some horses may not like this feel.

FIG. 3 shows a view of another embodiment of the crown piece. FIG. 3 is a transition or hybrid crown that combines features of FIGS. 1, 2, and 4, allowing the rider freedom and flexibility to choose from day to day or during a ride to move easily from double or single bridle configuration, as the bit straps attach independently and buckle on the top. However, in FIG. 3 the noseband is attached traditionally on the sides with buckles.

FIG. 4 shows a view of another embodiment of the crown piece. FIG. 4 incorporates traditional buckles on the sides but with the crown shape and throat latch as described herein, allowing for proper and maximum comfort for the horse. All buckles in FIG. 4 are for bits (single or double), and the double buckles are located on the side of the face and sold as a single or double configuration. FIG. 4 also includes a cutout for the ears for maximum comfort.

### DETAILED DESCRIPTION OF THE INVENTION

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

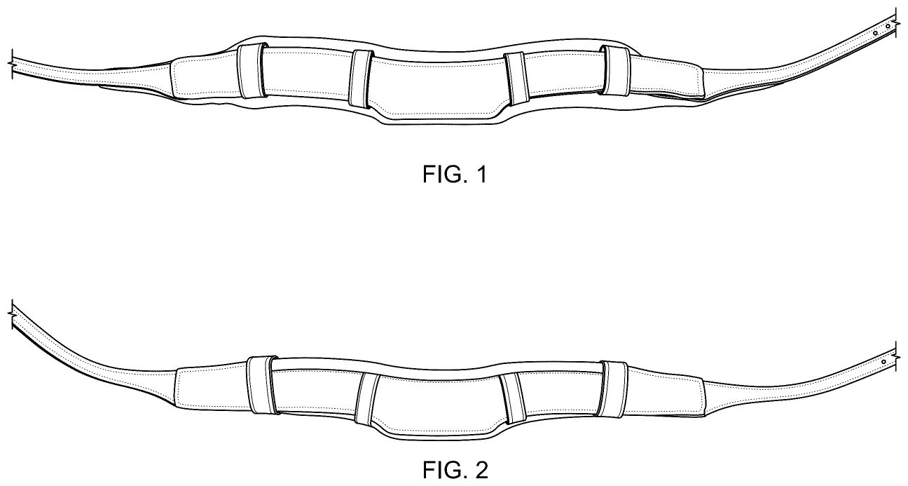

The disclosed technology addresses the need for an improved ergonomic crown piece system for equine bridles. As illustrated in FIGS. 1-4, one embodiment of crown piece system 100 according to the present invention includes innovative structural modifications that fundamentally reimagine how the browband interfaces with the crown piece.

Crown piece system 100 may include a crown piece body 110 constructed from any number of materials such as vegetable-tanned leather, synthetic leather alternatives, or bio-based composite materials that maintain structural integrity while providing necessary flexibility and durability under regular use conditions. Crown piece body 110 extends laterally from a central poll region over the horse's head, with terminal ends that connect to the cheek pieces of the bridle through various attachment mechanisms known in the equestrian art.

For all embodiments illustrated in FIGS. 1-4, crown piece system 100 incorporates a browband channel that prevents the browband from slipping and provides a smoother, continuous piece of leather against the very sensitive area where the browband lays on the horse's head. This design removes some of the friction and potential buildup of sweat, dirt, and debris that could get trapped in conventional browband configurations that loop over the top of the crown leather. The shape of the crown around the ears and over the poll is better shaped to conform more correctly than conventional and even so-called “ergonomic” crowns currently available.

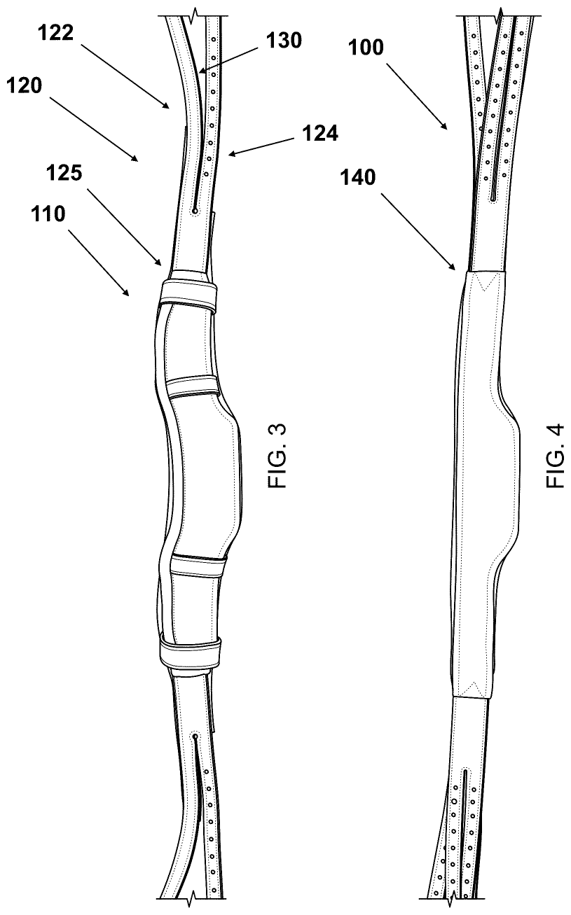

The defining innovation of crown piece system 100 is the incorporation of bilateral bifurcated zones 120, illustrated in FIGS. 3 and 4, but the concepts may be used for all designs, positioned at anatomically optimized locations corresponding to the browband attachment points. Each bifurcated zone 120 includes an upper leather strap 122 and a lower leather strap 124, with these components separated by a gap that forms browband passage opening 130.

Bifurcated zone 120 is strategically positioned to place browband passage opening 130 in an optimal anatomical location, immediately posterior to the base of the equine ear and superior to the temporomandibular joint (TMJ). This positioning is critical because it places the bulk of the browband attachment in an area where there is natural anatomical clearance, avoiding interference with the ear structure while simultaneously preventing pressure on the sensitive TMJ region.

Upper leather strap 122 serves as the primary structural element for browband attachment. After the browband passes through browband passage opening 130, it loops around upper leather strap 122, creating a secure mechanical connection that prevents lateral or vertical displacement of the browband during use. This looping configuration distributes the tensional forces from the browband across upper leather strap 122, which in turn is integrated with the main structure of crown piece body 110 through reinforced transition zones 125.

Lower leather strap 124 serves as the primary contact surface with the equine head in the critical poll region behind the ears. Because the browband loops around upper leather strap 122 rather than lower leather strap 124, the contact surface remains a clean, single-layer leather interface. This eliminates the traditional three-layer bulk (upper crown, browband loop, lower crown) and significantly reduces pressure concentration in this sensitive area.

Browband passage opening 130 typically has a vertical dimension of approximately 1.5 to 2.0 inches (38 to 51 millimeters), though this dimension may be optimized based on several factors including the width of the intended browband, the size and breed of the horse, and specific anatomical considerations. In some embodiments, the vertical dimension may range from 1.0 to 3.0 inches to accommodate various applications. The horizontal length of bifurcated zone 120 (the extent over which upper leather strap 122 and lower leather strap 124 remain separated) is typically between 0.5 and 1.5 inches, sufficient to allow easy passage of the browband while maintaining structural continuity of the crown piece.

Reinforcement stitching 140 may be incorporated at transition zones 125 where crown piece body 110 transitions into bifurcated zone 120. This stitching may employ traditional saddle-stitching techniques or modern box-stitch patterns, using high-tensile-strength thread materials such as polyester or nylon. The reinforcement ensures that the structural integrity of crown piece system 100 is maintained even under significant loading conditions, such as those encountered during training, competition, or when a horse resists contact.

In some non-limiting embodiments, lower leather strap 124 may include an inner cushioning layer 150 composed of foam padding, gel inserts, or soft leather underlays. This cushioning material provides additional comfort at the poll contact zone, further enhancing the ergonomic benefits of the design. The cushioning may be permanently affixed through adhesive bonding or stitching, or may be removable to allow for cleaning and replacement.

Crown piece system 100 may integrate with a throat latch component 160, which is a standard feature in many bridle configurations. The throat latch extends from one side of crown piece body 110 and fastens under the horse's throat to prevent the bridle from being pulled forward over the horse's ears. For all embodiments of FIGS. 1-4, there is a curved slope to the leather towards the neck from the crown for the attachment of the throat latch—this shape provides a better, more secure attachment that will not interfere with the throat because it is designed to sit a few inches forward on the cheek and will not flop around as the conventional hanging straight down system used by most other bridles. The integration of throat latch component 160 with the innovative bifurcated crown piece design maintains all traditional bridle functionalities while incorporating the enhanced ergonomic features.

The bilateral symmetry of bifurcated zones 120 is a key feature of the design. Both lateral sides of crown piece system 100 incorporate identical bifurcated structures, ensuring balanced loading and symmetric contact with the equine head. This bilateral configuration allows the rider or handler can easily thread the browband through both browband passage openings 130 and loop it around both upper leather straps 122, creating a secure four-point attachment that is both stronger and more comfortable than traditional designs.

Referring now to the specific embodiments illustrated in the drawings, FIGS. 1 and 2 show crown piece configurations that can be used as either a single or double bridle. For the convenience and economics of the rider, these embodiments provide total flexibility with one bridle purchase to use it as a double, single, with or without the noseband. The difference between the embodiment of FIG. 1 and FIG. 2 relates to the raised leather edge. In FIG. 1, the raised leather edge is designed to prevent any slippage of the bit/noseband straps from crossing over the back of the crown as a double measure, as the two sets of permanent keepers on both sides will also prevent any slippage. The embodiment of FIG. 1 has raised leather on the back of the crown and on the front located near the back of the ears. This raised area by the ears can help secure a more snug fit for feisty horses. The embodiment of FIG. 2 is exactly the same but does not have the raised leather on the area behind the ears, as some horses may not like this feel.

The embodiment of FIG. 3 represents a transition or hybrid crown that combines features of FIGS. 1, 2, and 4. This embodiment allows for the freedom and flexibility of the rider being able to choose from day to day or during a ride to move easily from double or single bridle, as the bit straps attach independently and buckle on the top. However, in FIG. 3 the noseband is attached traditionally on the sides with buckles.

The embodiment of FIG. 4 incorporates traditional buckles on the sides but with the crown shape and throat latch as described herein, allowing for proper and maximum comfort for the horse. All buckles in FIG. 4 are for bits (single or double), with the double buckles located on the side of the face. This embodiment can be sold as a single or double configuration. FIG. 4 also includes a cutout for the ears for maximum comfort.

Testing and field validation have demonstrated significant advantages of crown piece system 100 over traditional crown piece designs. Pressure mapping studies using sensor arrays placed between the crown piece and the horse's poll region show that the elimination of the traditional browband loop reduces peak pressure in the critical area immediately behind the ears. This pressure reduction correlates with observable improvements in horse comfort and behavior, including reduced head tossing, decreased ear pinning when the bridle is fitted, and improved acceptance of contact through the reins.

The anatomical positioning of browband passage opening 130 provides optimal clearance from the ear base, reducing the common problem of browbands that sit too high and cause the ears to be pushed forward or that rub against the ear base. Simultaneously, the positioning above the TMJ prevents the concentrated pressure that traditional browband loops create on this sensitive joint structure. Veterinary observations indicate reduced incidence of TMJ-related sensitivity and decreased poll soreness in horses regularly fitted with crown piece system 100.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

1. A crown piece system for equine bridles comprising:
a crown piece body member extending from a first lateral side to a second lateral side across an equine poll region;
a first bifurcated zone located at a first lateral position corresponding to a first browband attachment point; and
a second bifurcated zone located at a second lateral position corresponding to a second browband attachment point.

2. The crown piece system of claim 1, wherein each bifurcated zone comprises an upper leather strap; a lower leather strap; and a browband passage opening formed by a gap between the upper leather strap and the lower leather strap.

3. The crown piece system of claim 2, further comprising a browband, wherein the browband is configured to pass through the browband passage opening and loop around the upper leather strap.

4. The crown piece system of claim 3, wherein the lower leather strap is configured to maintain direct contact with an equine head in a region posterior to equine ears and superior to a temporomandibular joint.

5. The crown piece system of claim 4, wherein the browband passage opening has a vertical dimension of approximately 1.5 to 2.0 inches.

6. The crown piece system of claim 4, wherein the browband passage opening has a vertical dimension ranging from 1.0 to 3.0 inches based on browband width and equine anatomy.

7. The crown piece system of claim 4, wherein each bifurcated zone is positioned to place the browband passage opening immediately posterior to an equine ear base and superior to the temporomandibular joint.

8. The crown piece system of claim 4, wherein the upper leather strap and the lower leather strap maintain substantially parallel orientation within each bifurcated zone.

9. The crown piece system of claim 4, wherein the crown piece body member includes an integrated throat latch component.

10. The crown piece system of claim 4, wherein the first bifurcated zone and the second bifurcated zone are symmetrically positioned on both lateral sides of the crown piece body member.

11. The crown piece system of claim 4, further comprising reinforcement stitching at transition zones between the crown piece body member and each bifurcated zone.

12. The crown piece system of claim 4, wherein the lower leather strap includes cushioning material on a surface configured to contact the equine head.

13. The crown piece system of claim 4, wherein the crown piece body member includes a throat latch component having a curved slope towards the neck from the crown, wherein the curved slope is configured to position the throat latch forward on the cheek to prevent interference with the throat and reduce movement during use.

14. The crown piece system of claim 4, further comprising a raised leather edge on a rear surface of the crown piece body member configured to prevent slippage of bit straps or noseband straps across the back of the crown.

15. The crown piece system of claim 14, further comprising a raised leather area on a front surface of the crown piece body member located near the back of the ears, wherein the raised leather area is configured to provide a more secure fit.

16. The crown piece system of claim 4, further comprising permanent keepers positioned on both lateral sides of the crown piece body member, wherein the permanent keepers are configured to prevent slippage of bit straps or noseband straps.

17. The crown piece system of claim 4, wherein the crown piece body member includes ear cutouts configured to provide clearance for the equine ears, wherein the crown piece body member has a contoured shape around the ears and over the poll region that conforms to equine anatomy.

18. The crown piece system of claim 4, wherein the browband passage opening forms a browband channel that secures the browband against slippage and provides a continuous leather surface against the equine head, thereby reducing friction and preventing accumulation of sweat, dirt, and debris.

19. The crown piece system of claim 18, further comprising bit straps that attach independently and buckle on a top portion of the crown piece body member, wherein the independent attachment allows switching between single and double bridle configurations.

20. A method of assembling a bridle with an ergonomic crown piece system, comprising:
providing a crown piece body member having first and second bifurcated zones, each bifurcated zone comprising an upper leather strap, a lower leather strap, and a browband passage opening therebetween;
threading a browband through the browband passage opening of the first bifurcated zone;
looping the browband around the upper leather strap of the first bifurcated zone;
threading the browband through the browband passage opening of the second bifurcated zone;
looping the browband around the upper leather strap of the second bifurcated zone; and
positioning the crown piece body member on an equine head such that the lower leather straps contact the equine head posterior to ears and superior to a temporomandibular joint.
